(19) United States
(12) Patent Application Publication
(10) Pub. No.: US 2011/0041287 A1
(43) Pub. Date: Feb. 24, 2011

(54) SIDE LOAD CARRIER AND BALANCE SYSTEM FOR WINDOW SASHES

(75) Inventor: Wilbur James Kellum, III, Hilton, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 12/907,132

(22) Filed: Oct. 19, 2010

Related U.S. Application Data
(63) Continuation-in-part of application No. 12/568,314, filed on Sep. 28, 2009.
(60) Provisional application No. 61/101,694, filed on Oct. 1, 2008.

(51) Int. Cl. E05D 13/00

(52) U.S. Cl. 16/193

(57) ABSTRACT

The carrier is securable to the end of a window balance, including, but not limited to, spiral rod, extension spring, and block and tackle balances. The weight of the sash is borne by a sash assembly coupling portion of the carrier. The upward force exerted by the balance on the carrier during opening or closing of the sash is translated into a force urging the carrier toward the sash, until contact is made between the carrier assembly and the side of the sash. The translation of the upward force into a side-directed force eliminates or substantially reduces the friction that might otherwise have been created between the carrier and a carrier channel in the jamb. The side-directed force preferably removes the carrier from any contact with a carrier channel, thereby eliminating friction from the carrier rubbing against the carrier channel and even eliminating the need for a carrier channel.

### REFERENCE TO RELATED APPLICATIONS

This is a continuation-in-part patent application of co-pending application Ser. No. 12/568,314, filed Sep. 28, 2009, entitled “SIDE LOAD CARRIER AND BALANCE SYSTEM FOR WINDOW SASHES”, which claims benefit of Provisional Application No. 61/101,694, filed Oct. 1, 2008, entitled “CARRIER AND BALANCE ATTACHMENT SYSTEM FOR SIDE LOADING SASH WINDOWS”. The benefit under 35 USC §119(e) of the U.S. provisional application is hereby claimed, and the aforementioned applications are hereby incorporated herein by reference.

### BACKGROUND OF THE INVENTION

1. Field of the Invention

The invention pertains to the field of window sash balances. More particularly, the invention pertains to a carrier for attachment to a window balance.

2. Description of Related Art

Window balance assemblies located in the jamb channels of window frames assist with the raising and lowering of the window sash by providing a counterbalance force to gravity acting on the sash. The window balance is typically fixed at an upper end and is coupled to the window sash by a carrier at the lower end. The carrier moves up and down with the window sash by sliding up and down in a carrier channel in the jamb. The frictional losses caused by the sliding contact between the carrier and the carrier channel increase the forces required to raise and lower the sash of the window.

Spiral balances operate by using a torsion spring wound around a spiral rod to provide the counterbalance force. As the sash is moved up or down, the spiral rod turns, as does the torsion spring. In conventional spiral rod balances, the end of the spiral rod is attached to a carrier that moves up and down the carrier channel as the sash is moved. Because the torsion spring generates increasing torsional forces as the rod is pulled from the carrier, and because the carrier often does not tightly correspond to the size of the cross section of the carrier channel, the carrier tends to “twist” in the channel, thereby creating additional frictional forces between the carrier and the carrier channel.

### SUMMARY OF THE INVENTION

The carrier assembly preferably includes a carrier, a carrier encasement, and a carrier latch. The carrier is securable to the end of a window balance, including, but not limited to, a spiral rod, an extension spring balance, and a block and tackle balance. The weight of the sash is borne by a sash assembly coupling portion of the carrier. The upward force exerted by the balance on the carrier during opening or closing of the sash is translated into a force urging the carrier toward the sash, and contact is made between the carrier assembly and the side of the sash assembly. The translation of the upward force into a side-directed force eliminates or substantially reduces the friction that might otherwise have been created between the carrier and the carrier channel. In some embodiments, the side-directed force removes the carrier from any contact with the carrier channel, thereby eliminating friction from the carrier rubbing against the carrier channel and even eliminating the need for a carrier channel in the jamb. The translation force may be accomplished in several different ways, including, but not limited to, a pivot, a movement along a ramp, and a camming force.

### BRIEF DESCRIPTION OF THE DRAWINGS

FIG. 1 shows an isometric view of a carrier, an encasement member, and a carrier latch of a balance carrier assembly in an embodiment of the present invention.

FIG. 2 shows the assembly of FIG. 1 coupled to a window sash assembly.

FIG. 3 shows an isometric view of the carrier of FIG. 1.

FIG. 4 shows an isometric view of the carrier and the encasement member of FIG. 1.

FIG. 5 shows an isometric view of the carrier latch of FIG. 1.

FIG. 6 shows a cross sectional view of a carrier assembly on a wooden window frame assembly in an embodiment of the present invention.

FIG. 7 shows a cross sectional view of a carrier assembly on an aluminum or fiberglass window frame assembly with the carrier latch secured in a hole of the jamb in an embodiment of the present invention.

FIG. 8 shows the assembly of FIG. 7, where the carrier latch is secured on a ledge of the sash bracket.

FIG. 9 shows a schematic cross-sectional view of the contact between a carrier assembly and a window sash assembly in one embodiment of the present invention.

FIG. 10 shows a schematic cross-sectional view of the contact between a carrier assembly and a window sash assembly in another embodiment of the present invention.

FIG. 11 shows a schematic cross-sectional view of the contact between a carrier assembly and a window sash assembly in yet another embodiment of the present invention.

FIG. 12 shows a schematic isometric view of a carrier assembly, which supports the weight of a sash assembly by forming a horizontal contact line in an embodiment of the present invention.

FIG. 13 shows a schematic isometric view of a carrier assembly, where the side-directed force forms a vertical contact line with a sash assembly in an embodiment of the present invention.

FIG. 14 shows a schematic isometric cross-sectional view of a carrier assembly with an internal balance coupling structure in an embodiment of the present invention.

FIG. 15 shows an isometric view of a balance, a carrier, and a sash bracket in an embodiment of the present invention.

### DETAILED DESCRIPTION OF THE INVENTION

The lift of the balance applied to the carrier assembly forces the carrier assembly against the side of the window sash assembly to maintain the carrier assembly in a constant relative position with respect to the sash assembly so that the carrier assembly rides up and down with the sash as the sash is raised and lowered. The carrier assembly is pressed against the side of the sash assembly so that the carrier assembly moves with the sash and preferably does not engage a carrier channel formed in the jamb.

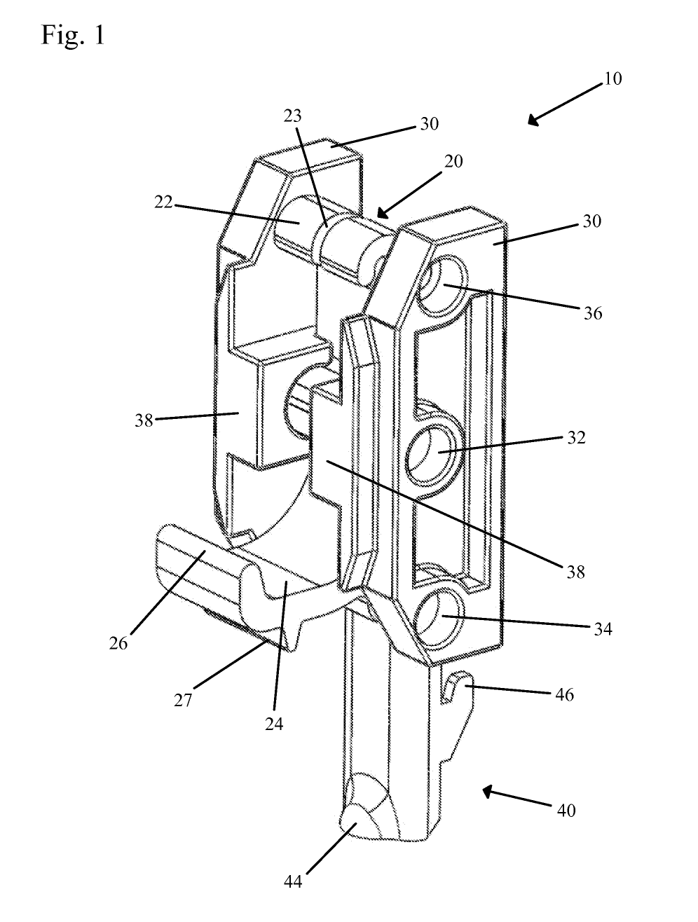

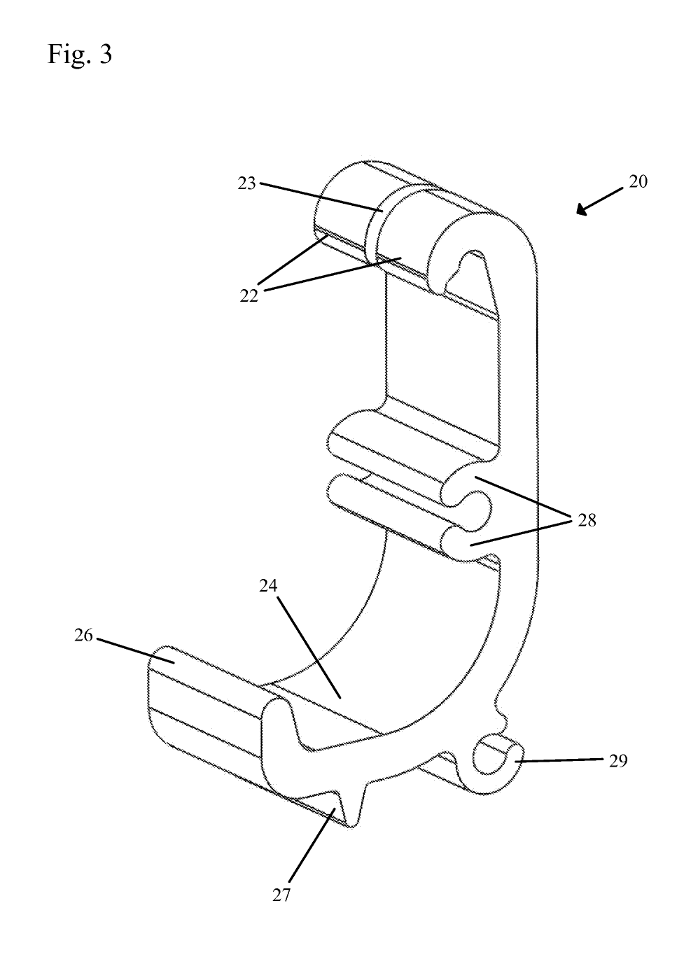

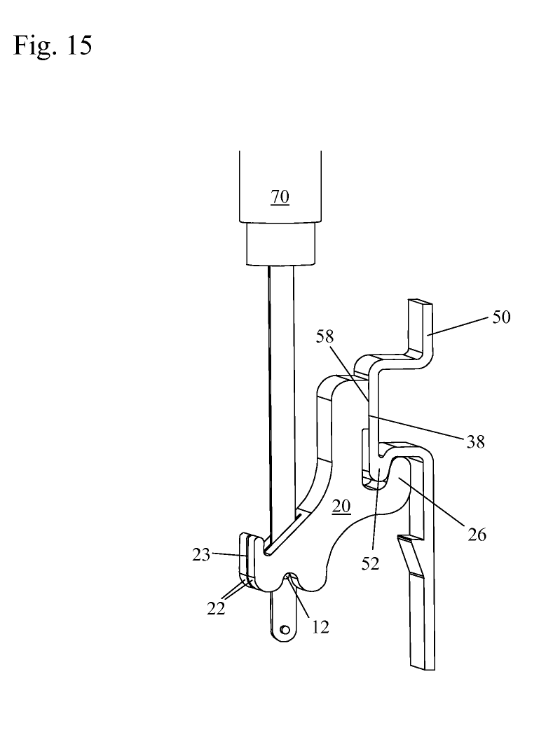

The carrier assembly, as used herein, refers to the structure which couples the balance to the window sash assembly. The carrier assembly includes a carrier with a balance coupling portion and a sash assembly coupling portion. These features couple, preferably reversibly to aid in assembly and disassembly, the carrier assembly to the balance and the window sash assembly, respectively. The carrier assembly also includes a sash assembly contacting portion, which is held in contact with the sash assembly by a side-directed force. In some embodiments, as shown in FIG. 15, the carrier assembly includes only a carrier and the sash assembly contacting portion is part of the carrier. Although the carrier is shown as a single integral piece herein, the carrier may be formed of more than one piece. In some embodiments, as shown in FIGS. 1-8, the carrier assembly may also include an encasement member coupled to the carrier, where the sash assembly contacting portion is part of the encasement member. In some embodiments, the carrier assembly includes a carrier latch.

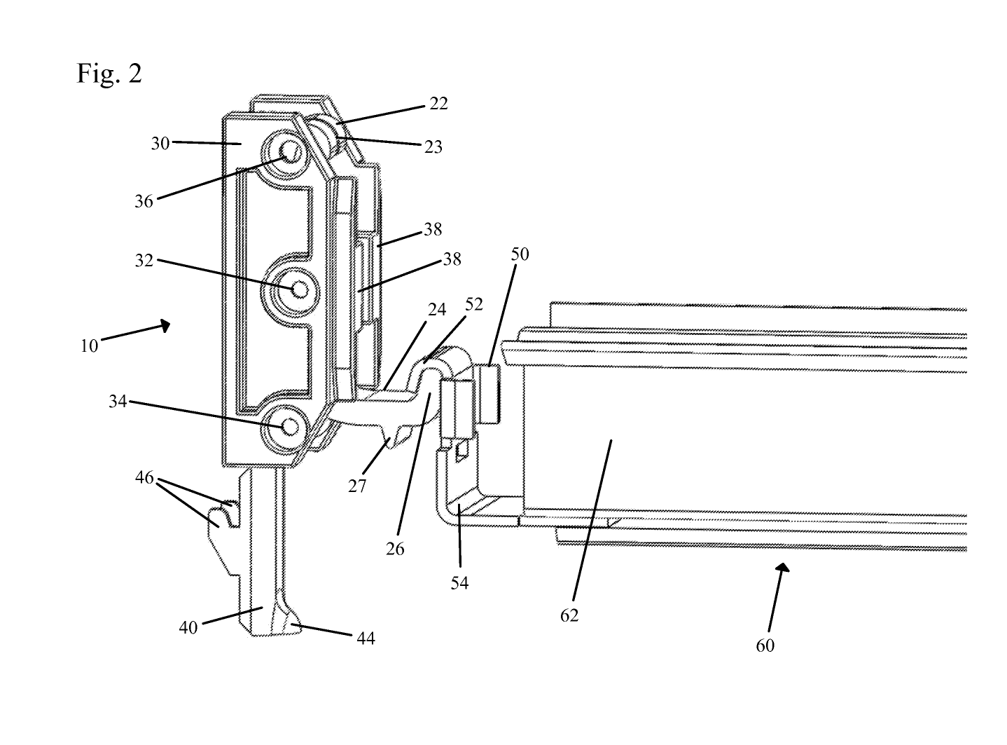

The window sash assembly, as used herein, includes the window sash. The window sash assembly also includes the carrier coupling portion and the carrier assembly contacting portion. In some embodiments, as shown in FIGS. 2, 6-8, and 15, the window sash assembly includes a sash bracket attached to the sash, and the carrier coupling portion and the carrier assembly contacting portion are part of the sash bracket. In other embodiments, the carrier assembly contacting portion is part of the window sash itself or the window sash stile. In other embodiments, the carrier assembly contacting portion and carrier coupling portion are part of the window sash or window sash stile and there is no sash bracket.

The elimination of the need for a carrier channel in the jamb for the counterbalance assembly provides a number of advantages and benefits. The jamb itself, without a carrier channel proportioned for guidance of the carrier, can be made with less material and less precision, thereby reducing manufacturing costs. The carrier assembly can be made of a greater variety of materials, because it no longer needs to form sliding contact with carrier channel walls, and it no longer needs to be durable enough to withstand repeated contact with the carrier channel walls while moving up and down in the jamb, again reducing manufacturing costs. Without a carrier channel for the carrier in the jamb, the space in the jamb may be made larger for incorporation of a greater variety of balance designs as well.

A balance coupling portion of the carrier securely but reversibly couples the carrier to the balance. In some embodiments, the carrier has a hook to attach to a fastener or eyelet at the end of the rod of a spiral rod balance. A sash assembly coupling portion on the carrier securely but reversibly couples the carrier to the window sash assembly. The carrier assembly receives at least a portion of the load of the window sash assembly in the assembled window. In some embodiments, the carrier includes an elongated platform with an upstanding ledge to seat a corresponding feature on the sash assembly offset from the line of pull of the balance. The upward pull of the balance on the carrier in combination with the offset connection to the sash causes select surfaces, edges, or points of the carrier assembly to contact select surfaces, edges, or points of the sash assembly with sufficient force to maintain the contact during upward and downward movements of the window sash. In embodiments with a spiral balance, this engagement of the carrier assembly with the sash assembly preferably occurs with sufficient force and breadth of contact such that the torsional forces of the torsion spring do not alter the contact points between the carrier assembly and the sash assembly.

In some embodiments, the carrier is mounted to an encasement member. The encasement member may include at least one surface, edge, or point which contacts and is held against the sash assembly as a result of the side-directed force. The carrier may be mounted to the encasement member by fasteners, including, but not limited to, pins, rivets, screws, or bolts, or any other mounting means such as press-fitting.

In some embodiments, a carrier latch coupled to the carrier assembly secures the carrier to the jamb so that the sash can be lifted off the sash assembly coupling portion during removal of the window sash or placed on the sash assembly coupling portion during installation of the window sash. In some embodiments, the carrier latch is hingedly actuated. In other embodiments, the carrier latch is slidably actuated. In some embodiments, the carrier latch hooks into at least one slot or hole at one of a plurality of pre-determined locations on the jamb to hold the carrier in place. In some embodiments, the carrier latch reversibly engages the sash assembly to maintain the carrier latch in a non-interfering position in the assembled window. In other embodiments, the carrier latch is removed from the carrier assembly after the window sash has been installed.

Referring to the embodiment of FIGS. 1-5, a carrier assembly 10 includes a carrier 20, a carrier encasement element 30, and a carrier latch 40. The carrier 20 includes a hook segment 22 with a slot 23 at an upper end of the carrier 20 for coupling to the window balance and an elongated and substantially horizontal platform 24 with an upstanding ledge 26 at the lower end for non-permanently but securely engaging a complementary hook extension 52 of a corresponding sash bracket 50, thereby sustaining the weight of the sash 60. Although the carrier 20 is shown as having only a single slot 23 in FIGS. 1-5, the carrier 20 may have more than one slot 23 in the hook segment 22 within the spirit of the present invention. The carrier 20 also includes a leg 27 extending downward from a bottom surface of the carrier 20 to limit rotation of the carrier latch 40 toward the sash 60. The bracket 50 includes an L-shaped brace 54 which is secured under a ledge located at the end of the rail 62 of the sash 60. Two fastener receptacles, a middle fastener receptacle 28 and a lower fastener receptacle 29 located below the middle fastener receptacle 28, are also formed in the carrier 20.

The carrier 20 is fixedly mounted in the carrier encasement element 30 by fasteners inserted through holes 32, 34 aligned with the middle fastener receptacle 28 and the lower fastener receptacle 29, respectively. The carrier encasement element 30 also includes an upper hole 36 to make the encasement element orientable with either side up. Two shoulder portions 38 having substantially flat vertical surfaces are formed on the carrier encasement element 30 on the side facing the sash 60 in the assembled window. The shoulder portions 38 engage the sash assembly as a result of the offset between the lifting and load forces so that the shoulders 38 establish the side-directed contact between the carrier and the sash and the carrier rides along with the sash as the sash moves up and down. In the assembled window, the fastener receptacles 28, 29 of the carrier 20 cooperate to press the carrier encasement element 30 against the sash assembly, thus clamping the carrier against the sash assembly so that the carrier no longer rubs up and down in a carrier channel.

Although two shoulder portions 38 are shown in FIGS. 1-5, the encasement member 30 may have a single shoulder portion or more than two shoulder portions within the spirit of the present invention. When used with a spiral balance, the shoulder portion or portions engaging the sash assembly are wide enough and tall enough to ensure that the carrier assembly remains pressed against the sash assembly and that any torsional force on the carrier is unable to twist the carrier. Although the encasement member 30 is shown extending above the hook segment 22 of the carrier in FIGS. 1-5, the encasement member 30 may include only the lower holes 32, 34 with the top portion of the illustrated embodiments not present so that the hook segment 22 of the carrier 10 extends above the body of the encasement member 30.

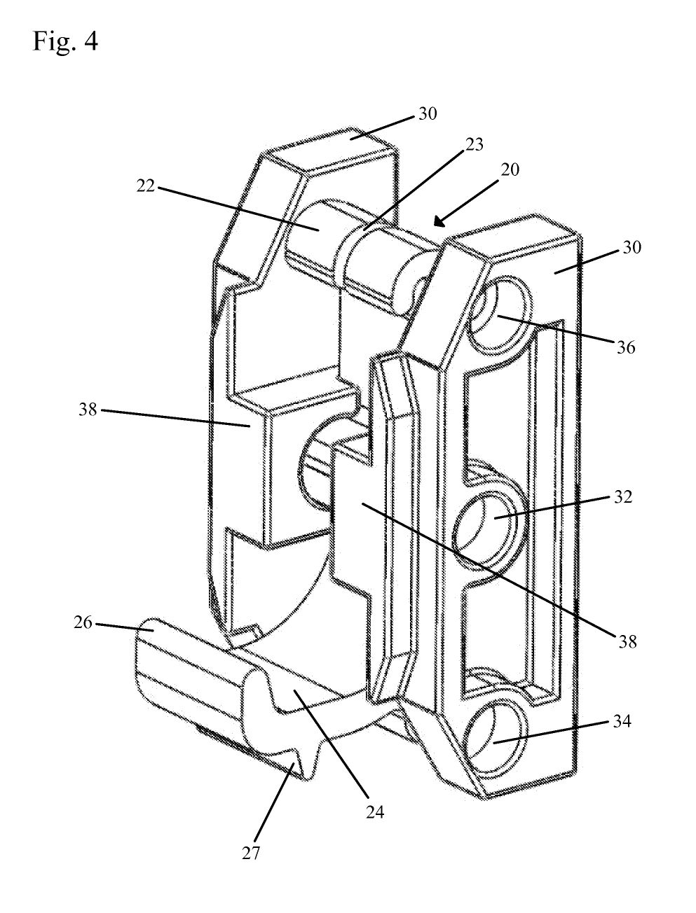

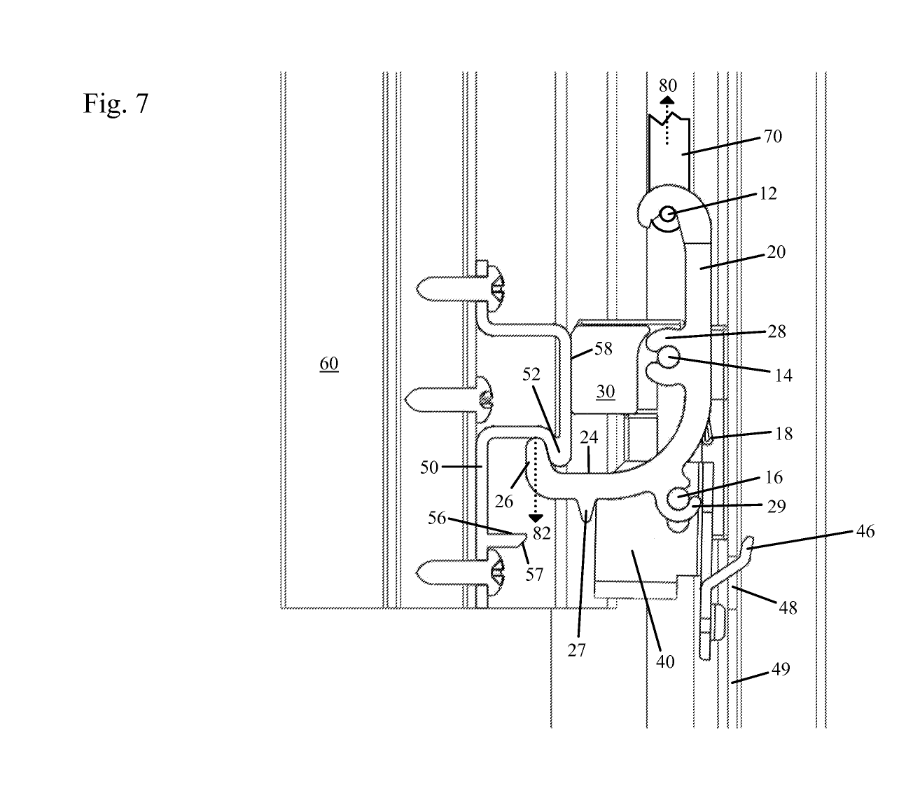

The carrier latch 40 includes a hook portion 42 at the upper end to hingedly engage a fastener extending through the hole 34 of the encasement member 30 and the lower fastener receptacle 29 of the carrier 20. A finger grip 44 is formed at the lower end of the carrier latch 40. The finger grip 44 aids in removing the carrier latch from the carrier assembly when the carrier latch is not in use and in attaching the carrier latch when the carrier latch is needed. Although the hook portion 42 in FIG. 5 is shown as having a width extending the width of the carrier, the carrier latch may alternatively have one or more hook portions which may straddle or otherwise not overlap with the lower fastener receptacle 29 to engage different portions of the bottom fastener mounting carrier in the encasement member 30 such that the carrier latch 40 can be more securely mounted on the fastener with a greater freedom of rotation about the fastener. Alternatively, the carrier latch may be slidingly actuated. The carrier latch 40 also contains a pair of integrally formed protrusions 46 which are designed to securely fit into corresponding slots 48 located at one of a plurality of predetermined locations within the wall 49 of the jamb (see FIG. 7). Upon securing the carrier assembly 10 at a specific location on the wall 49 of the jamb, the sash may be readily lifted away from the horizontal platform 24 of the carrier 20 to permit removal of the sash from the window frame.

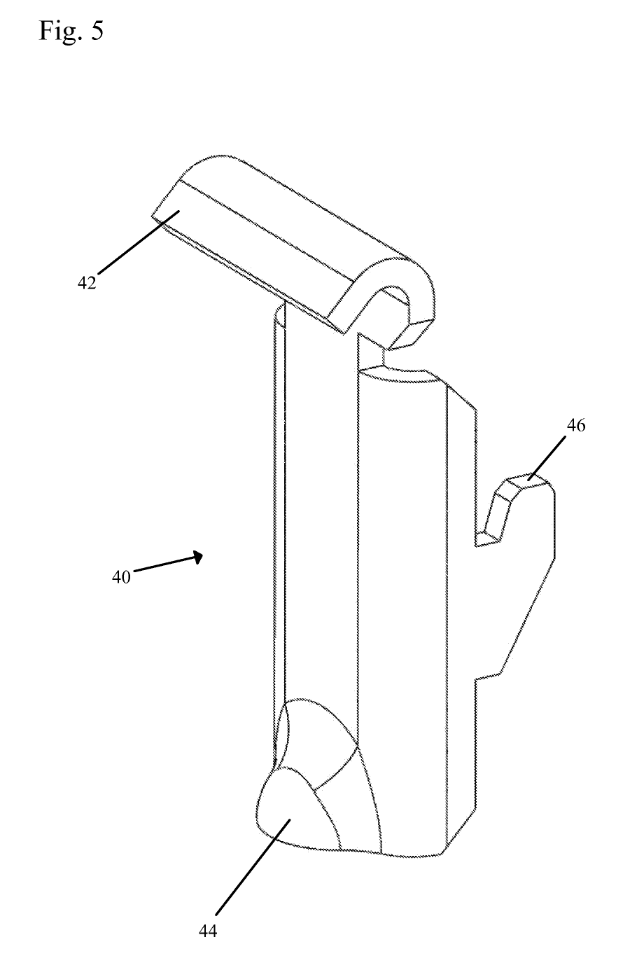

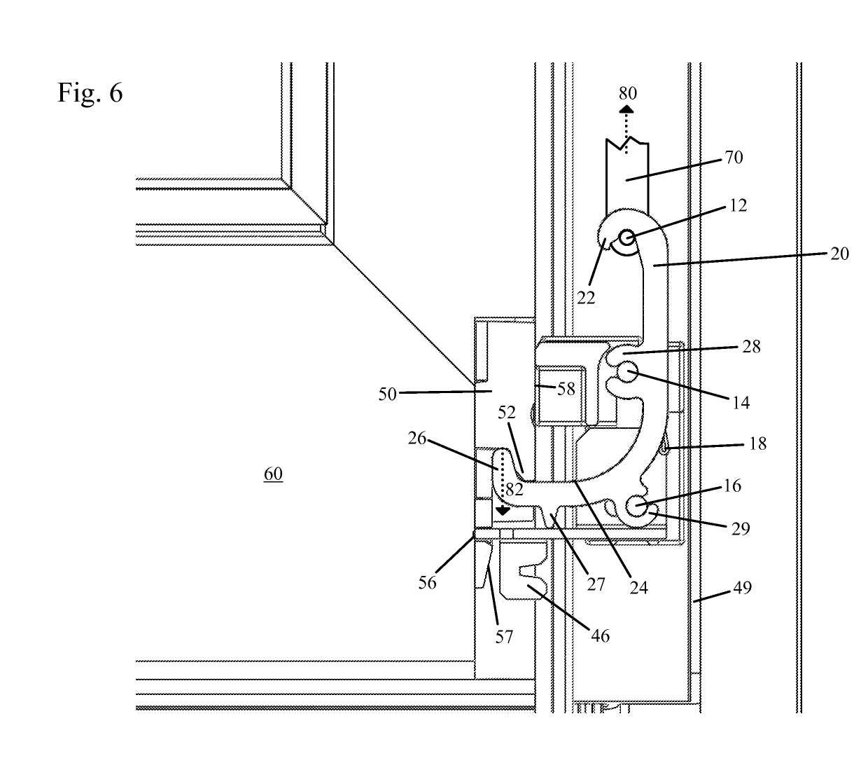

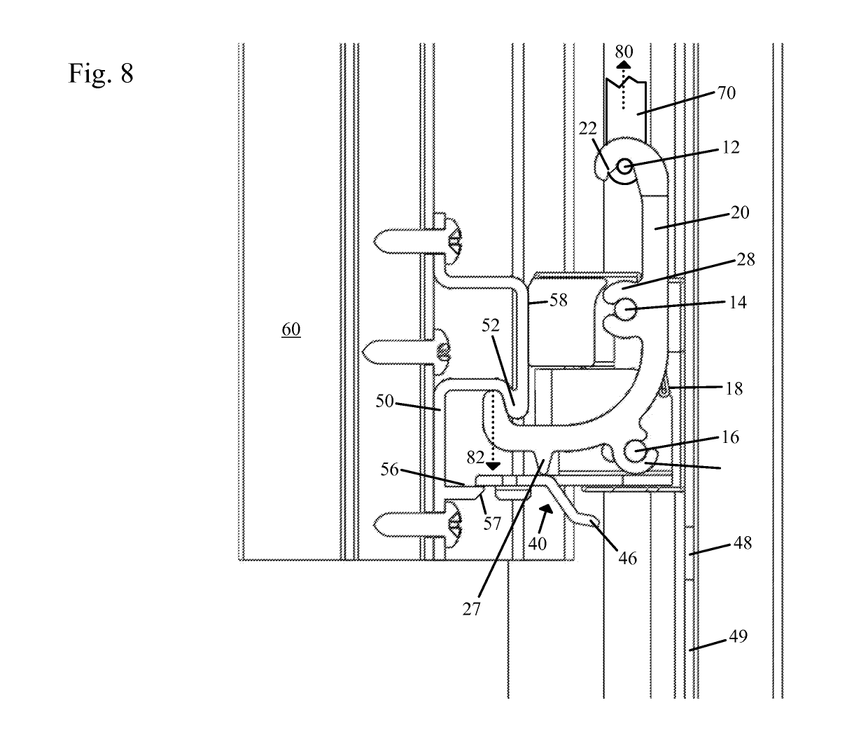

Referring to FIGS. 6-8, the carrier assembly 10 is preferably used in conjunction with a window balance 70. The carrier 20 is attached to the extendable or free end of the window balance 70 by the hook segment 22 at the upper end and a fastener 12. FIGS. 6-8 also show the fasteners 14, 16 for mounting the carrier 20 in the carrier encasement element 30. FIG. 6 shows a wooden window frame assembly. FIGS. 7 and 8 show an aluminum or fiberglass window frame assembly.

To install the sash 60 into the window frame, the balance 70 is first installed within a channel the jamb, traditionally by securing the upper end of the balance to the jamb by a screw, rivet, or other fastener. The carrier 20 is then coupled to the balance 70 and non-permanently held at a pre-determined location along the jamb by insertion of the protrusions 46 of the carrier latch 40 into at least one slot 48 in the wall 49 of the jamb as shown in FIG. 7. Next, the sash 60 is manipulated so that the sash bracket 50, already secured to the sash 60, is seated on the horizontal platform 24. The carrier latch 40 is then pivoted away from engagement with the slot 48 in the wall 49 of the jamb to engage a latch engagement element 56 of the sash bracket 50, as shown in FIGS. 6 and 8. For removal of the sash 60, upon securing the carrier assembly 10 at a specific location on the wall 49 of the jamb, the sash 60 may be readily lifted away from the horizontal platform 24 of the carrier 12 to permit removal of the sash from the window frame.

In embodiments of the present invention where the carrier latch 40 remains on the carrier assembly in the assembled window, it is desirable to maintain the carrier latch 40 in a position where it does not interfere with actuation of the window sash. In these embodiments, the sash assembly preferably includes a latch engagement element. The latch engagement element 56 may include a slot, as shown in FIG. 6 or it may be formed as a ledge, as shown in FIGS. 7 and 8. A spring element 18 on the back side of the carrier assembly 10, a finger grip 44 on the carrier latch 40, and a leg 27 of the carrier 20 may all assist with the engagement of the carrier latch 40 to the sash bracket 50. The spring element 18 is preferably mounted in the encasement member 30 and biases the carrier latch 40 toward the latch engagement element 56. A ramped portion 57 on the sash bracket 50 urges the carrier latch 40 into secure engagement with the latch engagement element 56. The sash bracket 50 also includes a carrier assembly contacting portion 58, which is substantially vertical and faces the carrier assembly 10 in the illustrated embodiments. In other embodiments, the carrier assembly contacting portion 58 is located on the window sash itself. In some embodiments, the shoulders 38 and the carrier assembly contacting portion 58 form a non-vertical area of contact. In some embodiments, the shoulders 38 and the carrier assembly contacting portion 58 form one or more points of contact, one or more lines of contact, or one or more areas of contact.

In the assembled window, the balance 70 applies an upward force 80 to one part of the carrier 20 and the sash bracket 50 applies a downward force 82 as a result of the weight of the sash assembly to another part of the carrier 20 offset from the upward force 80. This combination of forces results in a side-directed force driving the surfaces of the shoulder portions 38 of the carrier encasement element 30 to contact the carrier assembly contacting portion 58 of the sash bracket 50. The force is preferably sufficient to maintain non-sliding contact between the shoulder portions 38 and the carrier assembly contacting portion 58 as the window sash is moved up or down in the assembled window.

While the embodiments of the carrier assembly may be used with any balance, the following description focuses on spiral rod balances which exhibit a torsional force on the carrier. To install the carrier assembly 10, the end of the spiral rod 70 of a spiral rod balance is inserted through the slot 23 located within the hook segment 22 of the carrier 20. A fastener 12 located in proximity and secured to the end of the spiral rod 70 may be used to maintain engagement between the spiral rod 70 and the carrier 20.

As the spiral rod is extended further from the balance, the twisting force exhibited by the torsion spring increases. The side-directed force of the carrier assembly against the sash assembly is preferably strong enough to prevent the twisting force from the torsion spring from changing the contact points between the carrier assembly and the sash assembly.

Although the present invention has been described in terms of several preferred embodiments, alternative designs may be used within the spirit of the present invention. Various sash bracket designs may be used with carrier assemblies of the present invention. For example, three different sash bracket designs are shown in FIGS. 2, 6, and 7. Alternative sash brackets may be used for sashes made from different materials. Any sash bracket which securely but non-permanently couples the sash to the carrier balance may be used within the spirit of the present invention. Alternatively, the window sash may be formed with a carrier coupling portion so that no sash bracket is needed.

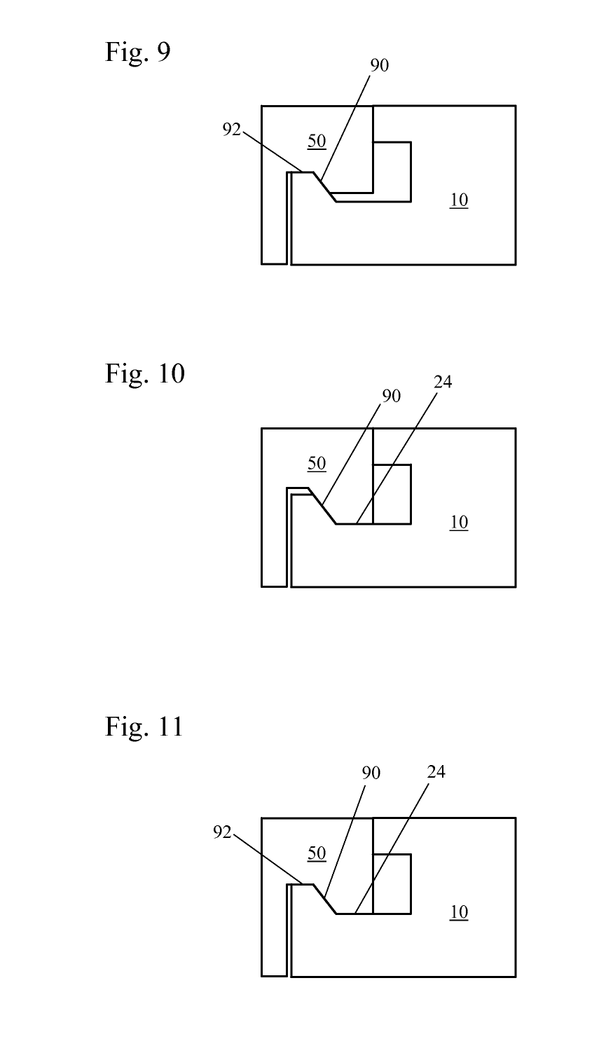

There are several preferred ways in which the weight of the sash 60 may be supported by the carrier assembly 10. FIG. 9 shows the weight being supported by contact with a slanted portion 90 and an end portion 92 of the carrier. FIG. 10 shows the weight being supported by contact with a slanted portion 90 and the platform 24 of the carrier. FIG. 11 shows the weight being supported by contact with a slanted portion 90, an end portion 92, and the platform 24 of the carrier. FIG. 12 shows a carrier assembly where the end portion 92 is designed to form a line of contact with the sash bracket to support a portion of the weight of the sash. The carrier assembly of FIG. 12 also includes a slanted portion 90 for supporting a portion of the weight of the sash.

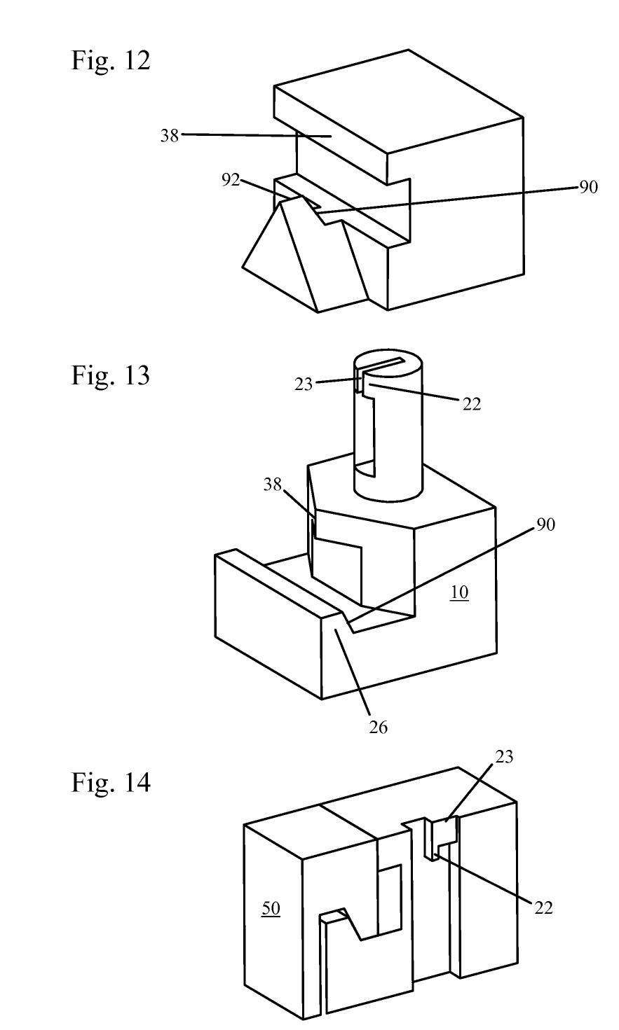

Numerous different possible contacts between the balance assembly and the window sash assembly may be used to maintain the balance assembly in non-sliding contact with the window sash assembly. The contact preferably establishes an engagement plane defined by at least three non-linear points of contact between the carrier assembly and the sash assembly. In some embodiments, a line and a point form the engagement plane. In some embodiments, the carrier assembly has an area of contact between the slanted portion 90 and the sash bracket and at least one shoulder portion 38 and the sash bracket to prevent the carrier assembly from twisting. In an alternate embodiment, the shoulder portion 38 may be designed to form only a line of contact with the carrier assembly contacting portion 58 of the window sash assembly, as shown in FIG. 13. The combined contact of the slanted portion 90 and the shoulder portion 38 in this embodiment with the sash bracket is sufficient to maintain non-sliding contact and to prevent twisting of the carrier assembly.

Alternative carrier assembly structures are shown schematically in FIGS. 13 and 14. The upper portion of the carrier has a cylindrical shape in FIG. 13 with a slot 23 in the top and flanking portions 22 for non-permanently coupling the balance to the carrier. The balance is coupled to the carrier assembly in an internal space of the carrier in FIG. 14. The end of the balance is maintained in a slot 23 in the carrier assembly by flanking portions 22 of the carrier assembly of FIG. 14. Although several means of coupling a balance to a carrier have been described herein, any method or means of securely but non-permanently coupling the balance to the carrier may be used within the spirit of the present invention.

Although FIGS. 1-14 show carrier assemblies where the balance coupling portion is located vertically higher than the sash assembly coupling portion in the assembled counterbalance system, the balance coupling portion may alternatively be located in vertical alignment with the sash assembly coupling portion or vertically lower than the sash assembly coupling portion as shown in FIG. 15. The carrier 20 includes a hook segment 22 with a slot 23 at a lower portion of the carrier 20. The window balance 70 is inserted into the slot 23 and reversibly coupled to the hook segment by a pin or knob 12 on the window balance 70. An upstanding ledge 26 in a middle section of the carrier 20 non-permanently but securely engages a complementary hook extension 52 of a corresponding sash bracket 50 attached to a window sash. The carrier 20 includes an integral shoulder portion 38, which applies a side load to the carrier assembly contacting portion 58 of the sash assembly as a result of the offset between the lifting and load forces so that the shoulder 38 establishes the contact between the carrier and the sash, and the carrier rides along with the sash as the sash moves up and down. In the embodiment illustrated in FIG. 15, the shoulder portion 38 is part of the carrier 20, and no encasement member is needed.

In some embodiments, the carrier, the carrier latch, the fasteners, the spring element, and the sash bracket are made of a metal and the encasement member is made of plastic. In some embodiments, the metal is aluminum. In other embodiments the carrier and the encasement member are formed of plastic as a single integral piece.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An improved carrier assembly comprising a carrier comprising a window balance coupling portion and a window sash assembly coupling portion, the improvement comprising:
the carrier assembly further comprising a window sash assembly contacting portion; and
the carrier being arranged such that the window sash assembly coupling portion sustains a weight of a window sash assembly offset from a line of pull of a window balance coupled to the window balance coupling portion;
wherein the window sash assembly contacting portion contacts the window sash assembly such that when the window balance exerts an upward force on the carrier assembly, the upward force of the window balance is converted into a side-directed force urging the window sash assembly contacting portion against the window sash assembly as a result of the weight of the window sash assembly on the window sash assembly coupling portion of the carrier being offset from the line of pull of the window balance.

2. The carrier assembly of claim 1, wherein the side-directed force maintains the carrier assembly in non-sliding contact with the window sash assembly when the window sash assembly is raised or lowered.

3. The carrier assembly of claim 1, wherein the carrier assembly contacts the window sash assembly at at least three non-linear points to form a plane of contact.

4. The carrier assembly of claim 1 further comprising a carrier encasement member coupled to the carrier and comprising at least one shoulder portion, wherein the shoulder portion serves as the window sash assembly contacting portion.

5. The carrier assembly of claim 1 further comprising a carrier latch comprising at least one protrusion such that the protrusion is insertable into a slot in a window frame to non-permanently hold the carrier assembly at a predetermined vertical location along the window frame.

6. The carrier assembly of claim 5, wherein the window sash assembly comprises a latch engagement element and wherein an end of the carrier latch is engageable with the latch engagement element when the protrusion is not inserted into the slot of the window frame.

7. The carrier assembly of claim 1, wherein the window sash assembly comprises a carrier coupling portion coupling the window sash assembly to the window sash assembly coupling portion of the carrier.

8. The carrier assembly of claim 1, wherein the window sash assembly coupling portion forms a peak such that the window sash assembly coupling portion forms a line of contact with the window sash assembly perpendicular to the side of the window sash assembly to support a portion of the weight of the window sash assembly.

9. An improved window sash counterbalance assembly comprising a window balance and a carrier assembly, the carrier assembly comprising a carrier coupled to the window balance, the carrier comprising a window sash assembly coupling portion, the improvement comprising:
the carrier assembly further comprising a window sash assembly contacting portion; and
the carrier being arranged such that the window sash assembly coupling portion sustains a weight of a window sash assembly offset from a line of pull of the window balance;
wherein the window sash assembly contacting portion contacts the window sash assembly such that when the window balance exerts an upward force on the carrier assembly, the upward force of the window balance is converted into a side-directed force urging the window sash assembly contacting portion against the window sash assembly as a result of the weight of the window sash assembly on the window sash assembly coupling portion of the carrier being offset from the line of pull of the window balance.

10. The window sash counterbalance assembly of claim 9, wherein the side-directed force maintains the carrier assembly in non-sliding contact with the window sash assembly when the window sash assembly is raised or lowered.

11. The window sash counterbalance assembly of claim 9, wherein the carrier assembly contacts the window sash assembly at at least three non-linear points to form a plane of contact.

12. The window sash counterbalance assembly of claim 9, wherein the carrier assembly provides no frictional resistance to raising and lowering the window sash assembly.

13. A window sash counterbalance assembly comprising:
a window balance coupleable to a jamb; and
a carrier assembly coupled to the window balance and coupleable to a window sash assembly, the carrier assembly comprising a window sash assembly contacting portion;
wherein the window sash assembly contacting portion maintains a non-sliding contact with the window sash assembly during raising and lowering of the window sash assembly without the carrier assembly contacting the jamb.

14. A window sash counterbalance assembly comprising:
a window balance coupleable to a jamb; and
a carrier assembly coupled to the window balance and coupleable to a window sash assembly, the carrier assembly comprising a window sash assembly contacting portion;
wherein the window sash assembly contacting portion maintains a non-sliding contact with the window sash assembly and wherein the carrier assembly only contacts the window sash assembly and the window balance during raising and lowering of the window sash assembly without the carrier assembly contacting the jamb.
